(19) United States
(12) Patent Application Publication
(10) Pub. No.: US 2005/0223645 A1
(43) Pub. Date: Oct. 13, 2005

(54) On-demand power-opening door

(75) Inventors: Martin D. Ericsson, Kennedy, NY (US); Kim C. Peterson, Jamestown, NY (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ELLISON BRONZE, INC., Falconer, NY (US)

(21) Appl. No.: 10/811,814

(22) Filed: Mar. 30, 2004

(51) Int. Cl. E05C 1/06; E05F 11/24

(52) U.S. Cl. 49/339

(57) ABSTRACT

An on-demand power-operating door arrangement includes a supporting structure forming a passage, a door mounted to the supporting structure for closing the passage, and a power operator for operating the door. The power operator includes a motor, and a linkage operably connected to the motor and arranged to move the door to the passage-opening position. The door is manually swingable from a closed position to an open position independently of the linkage. The linkage and the door are returned from the door-opened position by respective springs, the spring which returns the door being weaker than the spring which returns the linkage.

### BACKGROUND OF THE INVENTION

The present invention relates to an on-demand power-opening door.

Power-opening doors are often employed in commercial establishments to facilitate the opening of a door, especially by weak or handicapped persons. A power opening door includes a power operator attached to the door and which can be manually activated by a user, e.g., by actuating a switch located near the door. The power operator includes a motor, gearing, linkage, etc., mounted in a frame to which the door is mounted. The motor is connected to the linkage, e.g., by a first pivot joint, and the linkage is connected to the door, e.g., by a second pivot joint. When the switch is moved, the motor swings the arm about the first pivot joint, causing the arm to swing the door open. That door-opening movement works against a closer spring, causing the closer spring to store energy. Once the door has been swung open against the spring bias, the closer spring causes the door to close.

Such power operators also allow the door to be manually opened, i.e., independently of the motor, if the user pulls or pushes the door with enough force to overcome the resistance produced by the spring bias and various internal mechanisms of the power operator, e.g., the gearing, linkage, etc. The magnitude of the required force is typically great enough to make manual opening of the door difficult.

It would, therefore, be desirable to provide an on-demand power-opening door which is capable of easier manual opening than has heretofore been the case.

It would also be desirable to provide such a benefit in any type of power-opening door, including a so-called balanced door.

### SUMMARY OF THE INVENTION

The present invention relates to an on-demand power-operating door apparatus which comprises a door adapted for swinging movement between opened and closed passage-opening and passage-closing positions, and a power mechanism for operating the door. The power mechanism comprises a motor and a linkage which is operably connected to the motor and arranged to be driven thereby to move the door from the closed position to the open position. The door is manually swingable from the closed position to the opened position independently of the linkage.

Preferably, a first closer spring is provided for returning the linkage, and a second closer spring is provided for returning the door. The second closer spring is weaker than the first closer spring to facilitate the manual opening of the door, so the stronger tension of the first closer spring need not be overcome to manually operator the door.

The door is preferably of the balanced type.

### BRIEF DESCRIPTION OF THE DRAWINGS

The objects and the advantages of the invention will become apparent from the following detailed description of a preferred embodiment thereof in connection with the accompanying drawings in which like numerals designate like elements.

FIG. 1 is a front elevational view of a conventional balanced door apparatus.

FIG. 2 is a schematic top view of the balanced door apparatus of FIG. 1 depicting the door being moved from a closed position to an open position.

FIG. 3 is a front elevational view of a conventional on-demand power-operating balanced door apparatus.

FIG. 4 is a schematic top view of the apparatus of FIG. 3 depicting the door being moved from a closed position to an open position.

FIG. 5 is a front elevational view of an on-demand power-operating balanced door apparatus according to the present invention.

FIG. 6 is a schematic top view of the door apparatus of FIG. 5 with the door in a closed position.

FIG. 7 is a view similar to FIG. 6 depicting the door in a partially open state in solid lines and a fully open state in broken lines.

FIG. 8 is a view similar to FIG. 7 depicting a linkage of a power mechanism being returned from a door opening position, and also depicting the door being returned from an opened position.

FIG. 9 is a view similar to FIG. 8 depicting the door being manually opened independently of the linkage.

### DESCRIPTION OF A PREFERRED EMBODIMENT OF THE INVENTION

The present invention enables an on-demand power-opening door to be manually opened with less effort than has previously been the case. A preferred embodiment of the invention has been described in detail below with reference to a power-opening balanced door, but it will be understood that the invention is applicable to any type of power-opening door, including non-balanced doors.

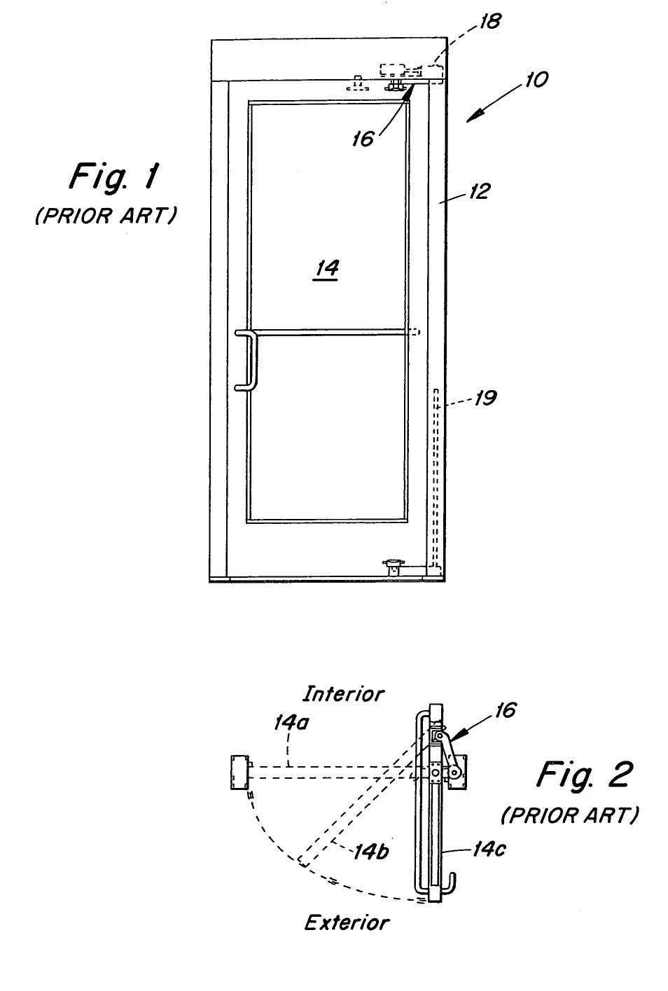

First, a brief review of the prior art is in order. Depicted in FIGS. 1 and 2 is a conventional balanced door apparatus 10 which comprises a framework 12 defining a passageway, a door 14, a hinge structure 16 connecting the door to the framework, and a speed control mechanism 18. The hinge structure defines two horizontally spaced vertical axes, i.e., a first axis at the frame, and a second axis at the door (as will be later discussed in detail). FIG. 2 shows the door 14 being swung between a closed position 14a, an intermediate position 14b, and a fully open position 14c (solid lines). After being manually opened, the door is automatically closed by a closer spring (herein called a hinge spring) in the form of a torsion spring 19. Such a door assembly is available from Ellison Bronze, Inc.

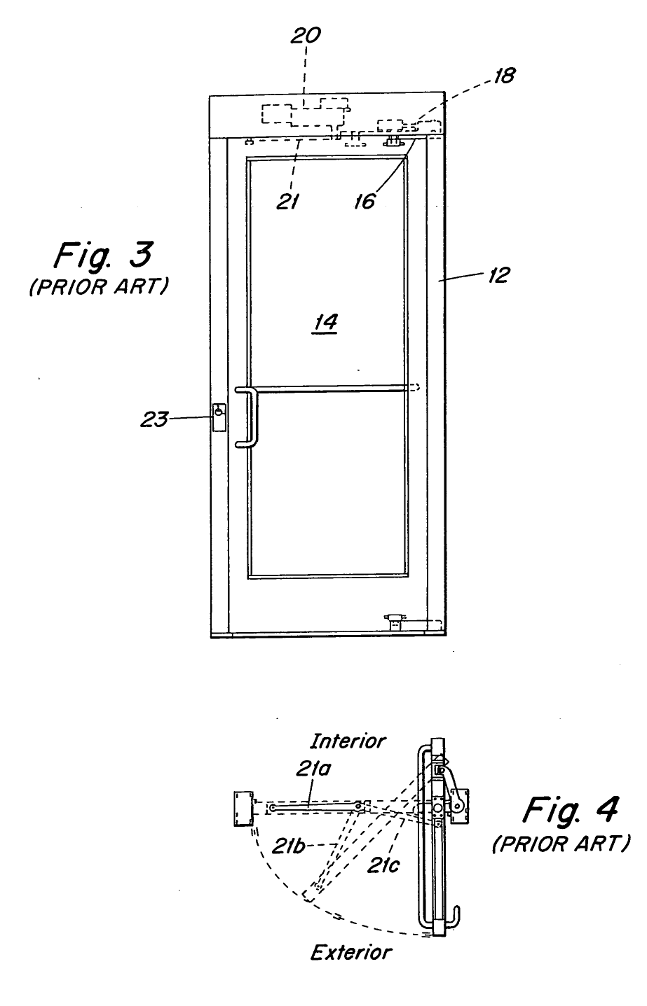

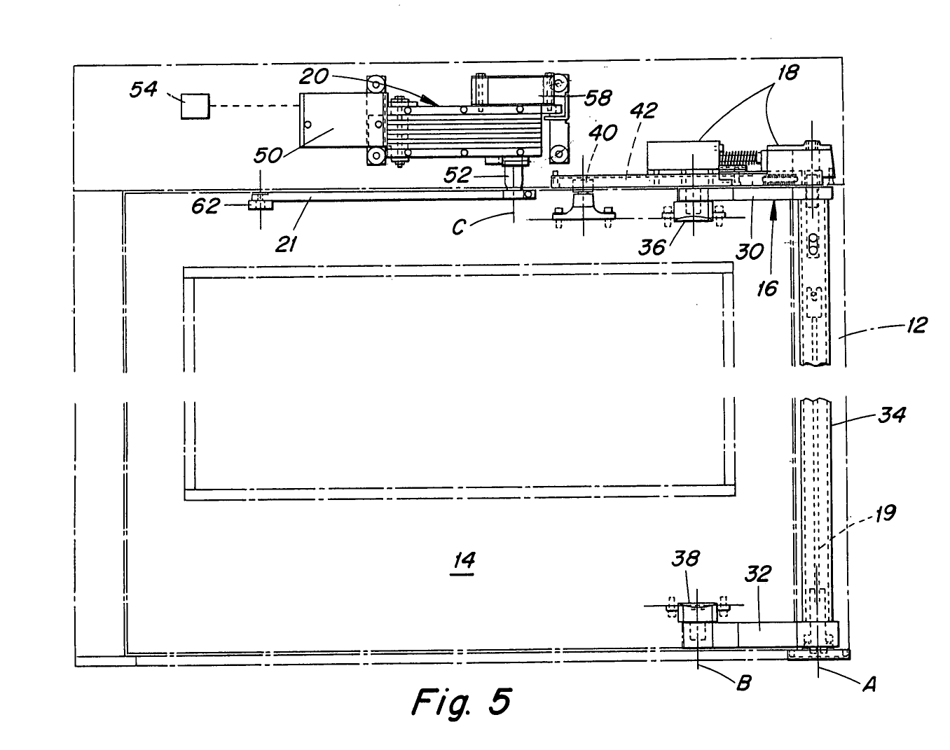

Optionally (and conventionally), the balanced door assembly can further include an on-demand power operator 20 (see FIGS. 3 and 4) which employs the force of a motor to mechanically rotate a linkage 21 which swings the door open in response to the activation of a manual switch 23 by a user. The linkage 21 has an inner end connected to a drive shaft of the motor, and an outer, free end slidably mounted in a channel disposed on a top edge of the door. FIG. 4 shows the linkage 21 moving between positions 21a, 21b and 21c as the door is swung open. Once the door has been opened, a closer spring (herein called a power spring) rotates the arm 21 to the closed position 21a, and the linkage 21 thus pulls the door closed. The presence of the power spring renders unnecessary the hinge spring 19 shown in FIGS. 1, 2, so the latter may be dispensed with if desired.

Since a power sprig in connection with a power operator must move gearing and linkage of the power operator when closing the door, it must be stronger than a hinge spring 19 used when no power operator is employed. That means that when a user manually opens a door 14 that is connected to a power mechanism (FIGS. 3, 4), the overall resistance which the user must overcome, i.e., the resistance of spring, gearing, linkage, is considerably greater than in the case where no power operator is used. Clearly, it would be desirable to minimize, as much as possible, the force necessary to manually open a power-opening door.

As will be explained below, that is accomplished by the present invention in a highly simple manner, requiring little modification to a conventional apparatus. In sum, in accordance with the presently claimed invention, both the hinge spring and the power spring are utilized, and the door is made capable of being manually opened independently of the linkage of the power operator.

A preferred embodiment of the invention will be described below, using the same numerals as used in FIGS. 1-4 to reference the same components. That embodiment is disclosed in connection with a balanced door, but it should be understood that the invention is applicable to types of doors other than balanced doors.

The door 14, which is positioned to open/close a passage, includes a pull handle 13 on one side (e.g., an exterior side), and a push bar 15 on the other (e.g., interior) side.

The door 14 is connected to the framework 12 by a hinge structure 16, and the framework 12 is, in turn, fixed to a wall (not shown). The framework, or the framework plus the wall, forms a door-supporting structure. The hinge structure includes upper and lower hinge arms 30, 32 each of which is fixedly connected (e.g., by welding) to a common vertical hinge shaft 34 that is rotatable about a stationary vertical axis A. The hinge arms 30, 32 are pivotably connected to respective upper and lower edges of the door by pivots 36, 38 which together define a common movable (non-stationary) vertical axis B.

A guide roller 40 is affixed to the upper edge of the door and is arranged to slide within a stationary horizontal guide channel 42 disposed in an upper portion of the framework. The roller 40 is freely rotatable about a vertical axis and travels within the channel as the door swings open and closed, in order to guide the movement of the door.

Disposed within the hinge shaft 34 is a torsion spring assembly 19 which biases the shaft, and thus the door, to a passage-closing position. The hinge shaft 34 is connected to a speed control device 18 which controls the closing speed of the door, and which is disposed in the upper portion of the framework 12. The speed control device 18 is conventional and need not be disclosed in greater detail.

Also operably connected to the door is the conventional power operator 20 which includes an electric motor 50, an output shaft 52, and the arm (linkage) 21. A speed control 54 regulates the return speed of the door under the action of a closer spring (herein called a power spring to distinguish it from the hinge spring 19) which can be in the form of a torsion spring schematically depicted at 58.

Connected to the output shaft 52 is the inner end of the arm 21 which defines the linkage for transmitting a door-opening force to the door upon rotation of the arm about the vertical axis C of the output shaft.

All of the structures thus far described are conventional. However, when the power mechanism 20 has been heretofore provided, the resistance to opening of the door is increased by the power spring and other internal mechanisms of the power operator. Thus, even if the power spring or the hinge spring were removed, the resistance to opening of the door is greater than would be the case if no power operator were provided. Also, the outer end of the arm 21 situated opposite the drive shaft 52 has been heretofore connected to the door in such manner that the arm can pull the door closed as well as push the door open. Thus, when a user opts to manually open the door, rather than activating the power mechanism, he or she must apply an opening force strong enough to overcome the resistance produced by the power spring 58 and other internal mechanisms such as gearing for example. As the door is opened, the arm 21 swings with the door and then pulls the door closed. As also noted earlier, the resistance of the power spring and other internal mechanisms is such that considerable force must be expended to open the door, as compared to the force necessary to overcome the resistance of a typical hinge spring.

That disadvantage is eliminated by the present invention which differs in two important ways from such prior art. Firstly, the hinge spring 19 is not removed; rather both the hinge spring 19 and the power spring 58 are retained.

Secondly, the outer end of the arm 21 is not connected to the door in such manner as to be able to pull the door closed. Rather, that outer end has a roller 62 arranged to push (but not pull) a vertical plate 63 affixed to the door. Thus, when the arm 21 is rotated by the motor 50, it will push the door open. The subsequent return of the arm 21 is caused by the power spring 58, and the return of the door 14 is caused by the hinge spring 19. Thus, the arm and the door are returned by separate forces. Importantly, it will be appreciated that since the outer end of the arm 21 is free to travel away from the door, and vice versa, the door can be manually opened independently of the arm 21, and thus independently of the power spring 58. As a result, the user need only overcome the bias of the weaker hinge spring 19 in order to manually open the door.

The arm 21 is herein described as a “linkage” even though it is not actually attached to the door, because it is arranged to be able to transmit a force from the motor to the door to push the door open.

Accordingly, by means of a relatively simple change in the overall arrangement of the apparatus, a power-opening door becomes easier to open by manual force. It will be appreciated that existing door apparatuses can be easily retrofit to achieve the benefits of the invention.

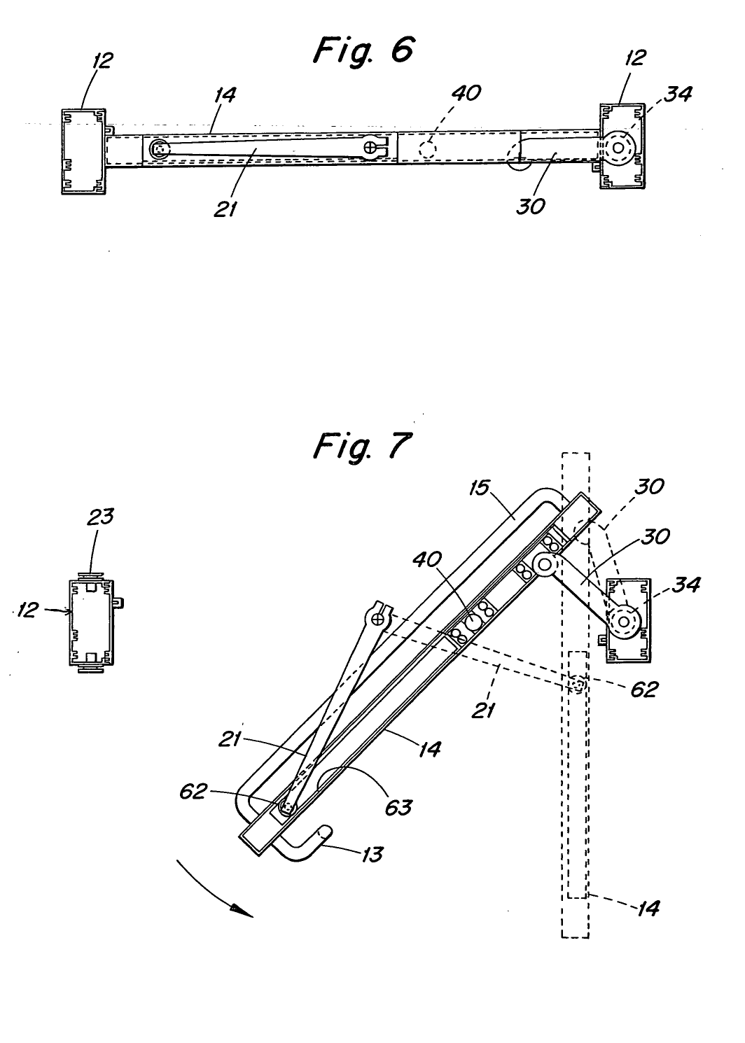

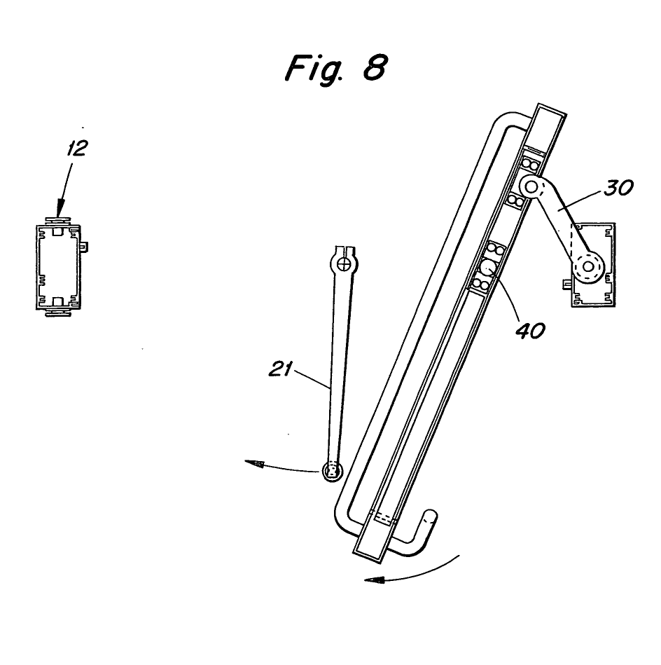

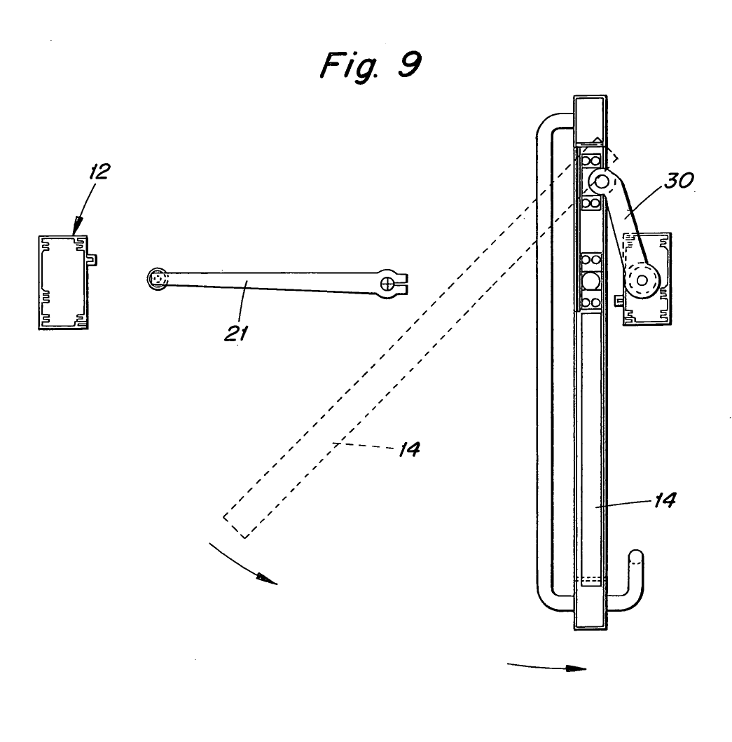

In operation, the door 14 is depicted in a closed state in FIG. 6. When the motor 50 is energized, e.g., by a person actuating the switch 23, the arm 21 pushes the door open as shown in FIG. 7. Thereafter, the power spring 58 returns the arm 21, and the hinge spring 19 returns the door, as shown in FIG. 8. In the event that a user wishes to open the door manually, he or she swings the door open against the hinge spring 19, while the power operator 20, including the arm 21 remains at rest, as shown in FIG. 9. Then, the hinge spring 19 returns the door.

As noted earlier, the invention is not-limited to power-opening balanced doors, but can be applied to any type of power-opening doors. Also, any type of springs can be utilized to provide the spring bias for returning the linkage and the door. Moreover, the linkage extending between the motor and the door could comprise a number of interconnected arms, rather than just one arm. Furthermore, the motor need not comprise an electric motor; for example, a fluid driven motor such as a pneumatic motor could be employed. Although the door which is opened by the power operator is disclosed as being closed by a power spring, the door could instead be closed by the power operator itself as the latter assumes a retracted condition.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. An on-demand power-operating door apparatus, comprising:
a door adapted for swinging movement between opened and closed positions; and
a power operator comprising:
a motor, and
a linkage operably connected to the motor and arranged to be driven thereby to move the door from the closed position to the opened position, the door being manually swingable from the closed position to the opened position independently of the linkage.

2. The apparatus according to claim 1 further including a first closer spring for returning the linkage; the apparatus further comprising a second closer spring for returning the door.

3. The apparatus according to claim 2 wherein the second closer spring is weaker than the first closer spring.

4. The apparatus according to claim 1 further including a framework forming a passage, the door being mounted to the framework.

5. The apparatus according to claim 4 wherein the door is connected to the supporting structure by a hinge structure, the hinge structure defining a stationary vertical axis of rotation at the supporting structure and a movable vertical axis of rotation at the door.

6. The apparatus according to claim 4 wherein the linkage comprises an arm having a first end defining a stationary axis at the framework, and a second end arranged to push against a portion of the door.

7. The apparatus according to claim 1 further including a manually operable switch for energizing the motor, the switch being accessible to persons positioned to pass through the passage.

8. The apparatus according to claim 1 wherein the linkage includes a roller for bearing against the door.

9. An on-demand power-operating door apparatus comprising:
a supporting structure forming a passage;
a door mounted to the supporting structure by a hinge structure defining a stationary vertical axis of rotation at the supporting structure, and a movable vertical axis of rotation at the door, the door being swingable about the stationary and movable axes between a passage-closing position and a passage-opening position; and
a power operator for opening the door comprising:
a motor mounted on the supporting structure,
a manually operable switch for energizing the motor and accessible to persons positioned to pass through the passage, and
a linkage having a first end operably connected to a drive shaft of the motor to be rotated thereby, and a second end arranged to push against the door, the door being manually swingable from the passage-closing position to the passage-opening position independently of the linkage;
a first closer spring for returning the linkage; and
second closer spring, weaker then the first closer spring, for returning the door.

10. The on-demand power-operating door apparatus according to claim 9 wherein the supporting structure comprises a framework attached to a wall.
